(19) United States
(12) Patent Application Publication
(10) Pub. No.: US 2005/0183564 A1
(43) Pub. Date: Aug. 25, 2005

(54) Violin support

(76) Inventor: David Allan Ripley, George, IA (US)

Correspondence Address: David Ripley, 404 W. Indiana Ave., George, IA, 51237, US

(21) Appl. No.: 10/934,938

(22) Filed: Feb. 17, 2004

(51) Int. Cl. G10D 3/00; G10G 5/00

(52) U.S. Cl. 84/327

(57) ABSTRACT

A violin support which fits around the neck of a musician and holds a violin in the playing position when used with a conventional shoulder rest, avoiding the need for the musician to hold the instrument by cradling it between the shoulder and chin. The violin support is light weight and low in profile.

### BACKGROUND OF THE INVENTION

1. Field of the Invention

This invention relates in general to musical instruments and in particular to a support device for violins and violas that enables the musician to play the Instrument without having to hold it by clamping it between the chin and the shoulder.

2. Description of Related Art

The violin and viola are generally held in position by clamping it between the jaw and the shoulder. Holding the violin in this manner creates neck tension that induces tension in the left arm, which in turn makes it difficult to learn to play the violin (or viola). The neck tension created by holding the violin in this manner can lead to overuse injuries of the neck and back and other health problems.

A number of violin support mechanisms or holders have been developed prior to this invention. For example see U.S. Pat. Nos. 4,193,027, 413,087, 1,337,459, and 2,576,018. The failure of these patented devices to gain popular acceptance indicates that these inventions have their shortcomings. They have not provided a simple stable design as the present invention does; they have not provided an uncomplicated method of attaching the support mechanism to the violin; they have not been as fully adjustable nor as low profile as the present invention. There is no known device that provides the violinist with a support mechanism that eliminates the need to use the jaw and shoulder to hold the violin that is simple in its design and yet fully adjustable. The present invention provides a support device for the violin (viola) that eliminates the need to hold the instrument with the jaw and shoulder that offers a simpler method of attaching the support mechanism to the violin and to the musicians body, offers greater stability, greater unobtrusiveness and is more fully adjustable than the previous prior art inventions.

### SUMMARY OF THE INVENTION

The principle object of the present invention is to provide a method of supporting or holding the violin (or viola) that eliminates the need to employ the jaw and shoulder to hold it.

It also is an object of the present invention to provide such a device, which is of simple, inexpensive construction.

Another object is to provide such a device that attaches to the body of the musician in a simple and unobtrusive manner.

A further object is to provide such a device that is stable when attached to the body.

Another object is to provide such a device that is fully adjustable so the musician can place it in his or her preferred position.

The foregoing objects can be accomplished by providing a violin (viola) support device that is configured to go partially around the neck of the musician (the opposite side of the neck from the side where the violin is held) and engage the lower back of the neck and the upper part of the back. The violin/viola support is used in conjunction with a standard violin/viola shoulder rest that engages the shoulder and upper part of the chest on the side that the instrument is held. The support is formed from two separate pieces, which are connected together during use: the neck-engaging part or neck-hook and the instrument support base which connects to the rear of the instrument over the tailpiece and held in place with a standard chinrest turnbuckle clamp. Stability of the instrument is achieved by the manner in which the neck-hook and shoulder rest engage the musician. The neck-hook has a peculiar shape and curvature and rests on the back of the neck and upper back and the shoulder rest is positioned on the back of the instrument so as to engage the shoulder and upper chest making for a very stable configuration. In the preferred embodiment, the hook of the support device is rod shaped and adjustably connected to the instrument support base through a hole in said support base, so as to slide forward or back and also rotate on the rod axis and is held in place with a set screw. This allows the tilt of the violin to be adjusted by rotating the violin on the axis of said neck-hook rod and also allows for adjusting the position of the instrument relative to the user by adjusting of the rod forward or backward in the support base attachment hole. The neck-hook is made of vinyl covered metal rod, preferably copper or aluminum so that it is easily bent and yet retains its shape. This allows for fine adjustments to be made in order to accommodate widely varying sizes of users.

It is therefore among the objects of the invention to improve over past instrument support devices by providing a violin/viola support which is easily assembled and secured to the body, which is of very low profile in use and which provides a highly stable support for the instrument, eliminating the need for the musician to use his chin and neck for retaining the instrument in place during playing. These and other objects, advantages and features of the invention will be apparent from the following description of a preferred embodiment, considered along with the accompanying drawings.

### BRIEF DESCRIPTIONS OF DRAWINGS

FIG. 1 is a perspective view showing the instrument support device attached to the musicians body and supporting a violin.

FIG. 2 is a perspective view showing the instrument support device attached to the musicians body looking at the musician from the rear and showing the neck-hook engaging the musicians back.

FIG. 3. is a top perspective showing the instrument support device attached to a violin.

FIG. 4 is a side perspective showing the instrument support device attached to a violin.

FIG. 5 is a rear perspective showing the instrument support device attached to a violin.

FIG. 6 is a side perspective showing the neck-hook part of the instrument support device separated from the instrument support base.

FIG. 7 is a front perspective of the instrument support base as seen from the rear or tailpiece end of the violin.

### DETAILED DESCRIPTION

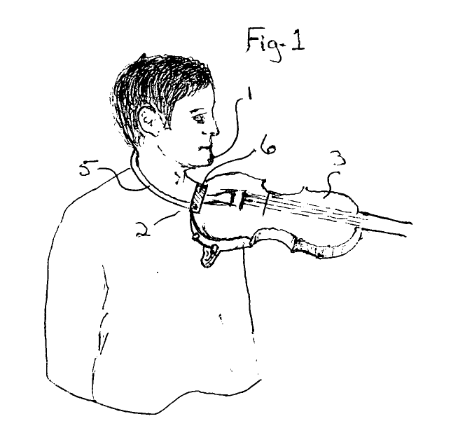

In the drawings FIG. 1 shows a musician 1 wearing an instrument support device, generally identified by the reference number 2, which shows a preferred embodiment of the invention. The instrument support 2 holds a violin 3 or viola at the left shoulder of the musician, so that the near base edge of the instrument rests on the musicians left shoulder and upper chest but avoiding the need for the musician to hold the instrument in place using the conventional method of holding the instrument using his chin.

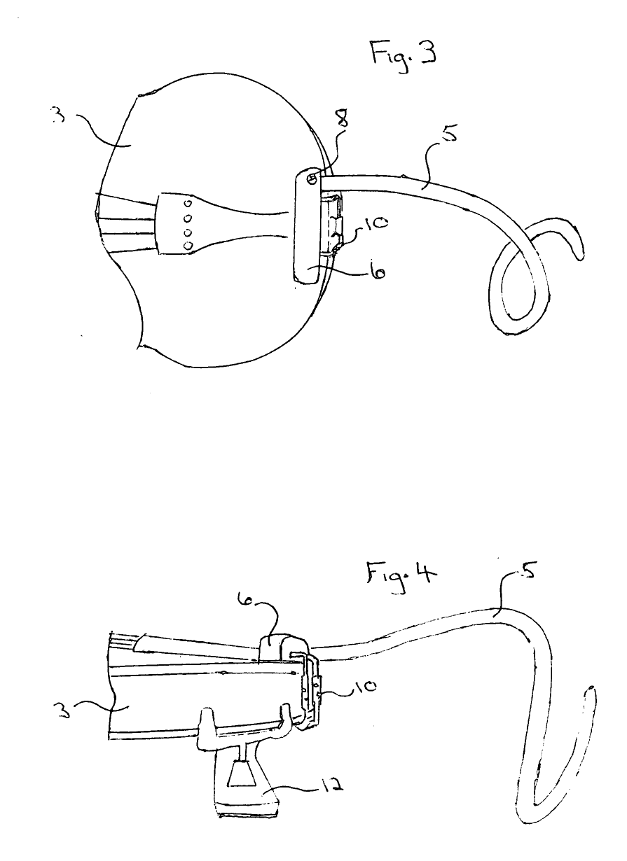

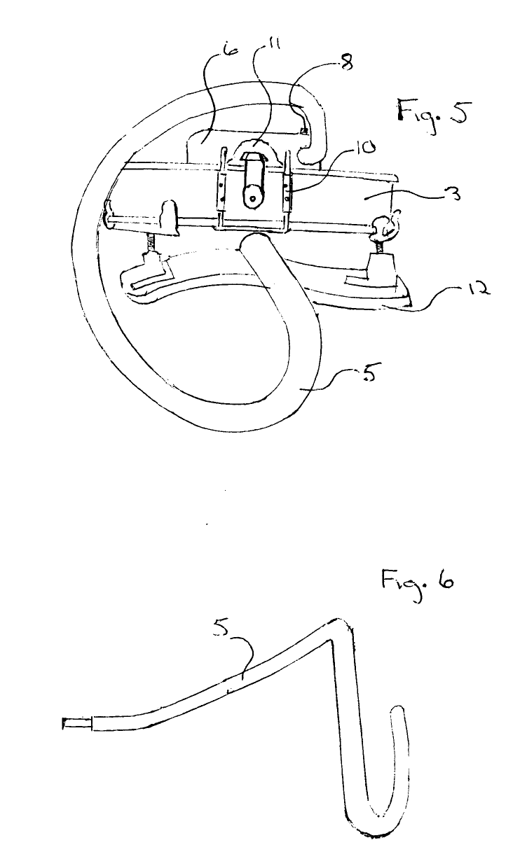

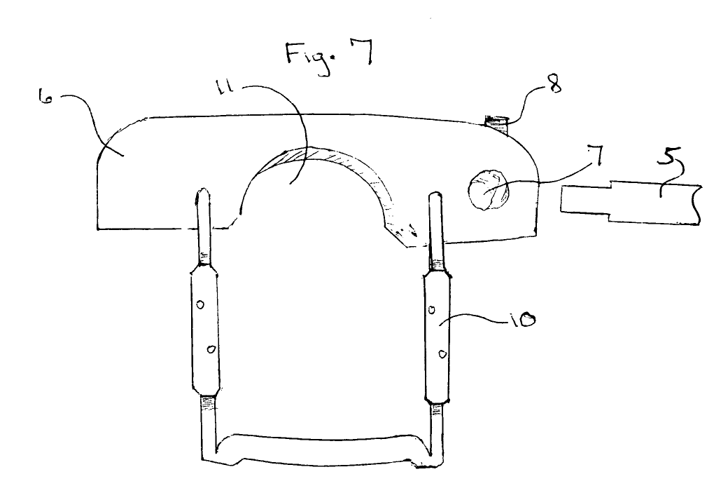

The instrument support device 2 includes a neck-hook 5 or neck and back engaging portion and an instrument support base 6 that is used as a means of attaching the neck-hook to the instrument. FIGS. 3 through 7 show details of the various components of the instrument support device, and the following discussion refers to all the drawing figures.

As illustrated, the instrument support device 2 of the invention is preferably low profile and hardly noticeable when used by the musician. The neck-hook or neck and back engaging device 5 thus comprises a small diameter vinyl covered rod 7 (preferably made of copper or aluminum as they are easily bent) which is connected to the instrument support base 6 through a hole 7 in the support base 6 and held in place with a setscrew 8.

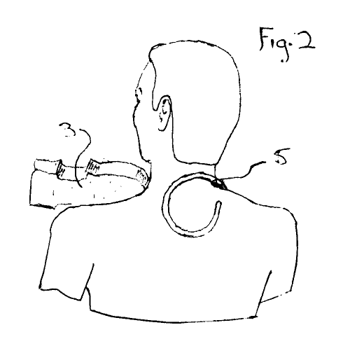

As shown in FIG. 1 and FIG. 2 the neck-hook 5 goes around the right side of the musicians neck (the side opposite the side on which the instrument is held), continues around and engages the lower part of the of the back of the neck and upper part of the back. In the front the neck-hook 5 crosses diagonally downward and across the lower aspect of the neck and attaches to the instrument support base 6 on the violin 3. The instrument support device 2 is used in conjunction with a standard shoulder rest 12 as shown in FIGS. 1, 4 and 5. While the neck-hook 5 of the instrument support 2 engages the neck and back the shoulder rest 12 engages the shoulder and upper chest thus allowing full support of the instrument.

The instrument support base 6 comprised of wood or plastic is best shown in FIG. 7. The support base 6 has a hole 7 for attachment of the neck-hook 5, a setscrew 8, a semicircular cutout 11 which prevents the support base from engaging the tailpiece of the violin and a standard chinrest clamp 10 which is used to attach the support device 2 to the violin 3. Movement of the neck-hook 5 forward or backward in the support base hole 7 and rotation of said neck-hook around its attachment axis affords many adjustments of the instrument support device, for accommodating different users and varying positions instrument placement.

The neck-hook has a peculiar curvature and shape, which is best visualized by referring to FIGS. 3 through 6. In addition to using the support base hole 7 to make instrument positional adjustments, adjustments can also be made by appropriately bending the neck-hook rod.

Another embodiment of the instrument support would be in the case of an electric violin whose body or a portion of it is often made of solid wood, the support base could simply be a hole drilled in the violin body with an accompanying setscrew to hold the neck-hook in place.

Another embodiment of the instrument support device would be where the support base is attached to the endpin that holds the tailpiece of the instrument in place or even where the support base itself is a modified endpin.

The foregoing description of the preferred embodiment of the invention has been presented for the purposes of illustration and description. It is not intended to be exhaustive or to limit the invention to the precise form disclosed. Other modifications and variations are possible in light of the above disclosure. It is intended that the scope of the invention be limited not by this detailed description, but rather by the claims appended hereto.

1. An improved support for a violin or viola, for supporting the instrument on the musician's body and avoiding the need for gripping the instrument between the musician's chin and shoulder, comprising,
neck-hook-means for fitting onto the body of the musician user and for engaging the back of the neck and upper back of the musician; and
instrument support base means for attaching to the instrument, including two instrument support base connection means, one for connecting said neck-hook means to said instrument support base means and one for attaching said instrument support base means to the instrument and further including adjustment means for adjustment of the position and orientation of the instrument support means to afford a full range of adjustment of the instrument in positions adjacent to the musician's other shoulder;
the musical instrument support thereby stably supporting the instrument on the musician in position to be played, when used in conjunction with a standard shoulder rest, without engagement of the chin with the instrument.

2. The musical instrument support according to claim 1, wherein the neck-hook means comprise a rod-like member curved and formed into an appropriate shape for engagement of the musician on the back of the neck and upper back and with said neck-hook means going from the instrument around the side of the neck opposite to the side of the neck on which the instrument is held.

3. The musical instrument support according to claim 1, wherein the instrument support base means comprises a rectangular block that has a bore for receiving the end of the neck-hook means, a setscrew for securing the neck-hook means to said block and a clamp means for attaching said instrument support base to the instrument.
